(19) United States
(12) Patent Application Publication
(10) Pub. No.: US 2002/0024414 A1
(43) Pub. Date: Feb. 28, 2002

(54) Fuse and fuse-mounting electric connection box

(76) Inventors: Tatsuya Sumida, Yokkaichi-City (JP); Yukitaka Saito, Yokkaichi-City (JP); Noriko Kobayashi, Yokkaichi-City (JP)

Correspondence Address: CASELLA & HESPOS, 274 MADISON AVENUE, NEW YORK, NY, 10016

(21) Appl. No.: 09/939,314

(22) Filed: Aug. 24, 2001

(30) Foreign Application Priority Data
Aug. 25, 2000 (JP) 2000-255539
Mar. 8, 2001 (JP) 2001-235548

(51) Int. Cl. H01H 85/04

(52) U.S. Cl. 337/158

(57) ABSTRACT

A fuse includes a casing (2) made of an insulating resin, and a conductor having one input terminal (3), plural output terminals (4A, 4B) and fusible portions (5A, 5B) each interconnecting the input terminal (3) and the corresponding output terminal (4A, 4B), the conductor being mounted within the casing (2). Distal end surfaces (3a, 4Aaand 4Ba) of the terminals (3, 4a and 4B) and one end surface of the casing (2) are disposed on a common plane. Plural pairs of notches (6A to 6C) are formed in both surfaces of the casing (2), and each pair of notches extend a predetermined distance from the distal end surface of the corresponding terminal (3, 4A, 4B) so that each of the terminals (3, 4A and 4B) is partially exposed. The exposed portion of each of the terminals (3, 4A and 4B) serves as an electrical contact portion with a mating terminal.

### BACKGROUND OF THE INVENTION

1. Field of the Invention

This invention relates to a fuse and an electric connection box for fuses. More particularly, the invention is directed to a construction in which the height of the fuse mounted on the electric connection box is reduced to achieve a compact design of the electric connection box, and to reduce the number of the fuses.

2. Description of the Related Art

A fuse 51 used in electric connection box of an automobile is identified by the numeral 51 in FIG. 8. The fuse 51 includes a casing 52 made of an insulating resin, and input and output terminals 53 and 54 that project from the casing 52. A fusible portion 55 is disposed in the casing and interconnects the input and output terminals 53 and 54. The fuses 51 are mounted in an electric connection box (not shown), such as a junction box for an automobile. When excess current flows between an electric power source and a load, such as a piece of electric equipment, the fusible portion 55 melts, thereby interrupting the excess current.

The electric connection box includes bus bars 56, and the input and output terminals 53 and 54 of the fuse 51 are connected to the bus bars 56. The bus bars 56 are bent at their distal ends to define a tab 57, as shown in FIG. 9, and a relay terminal 58 is fit on and connected to the tab 57. As shown in FIG. 10, the relay terminal 58 is received within a terminal-receiving portion 60 of the housing 59, so that a distal end of the relay terminal 58 faces an opening 60a in the terminal receiving portion 60. The relay terminal 58 has a proximal end with a first contact portion defined by two contacts 58a and 58a. The relay terminal also has a distal end with a second contact portion comprising two bent contacts 58b and 58b. The tab 57 is inserted between the contacts 58a and 58a, and is press-contacted therewith, so that the tab 57 is connected to the relay terminal 58. On the other hand, a terminal 53 or 54 of the fuse 51 is passed through the opening 60a and between the contacts 58b and 58b for press-contact therewith. Thus, the input or output terminal 53 or 54 is connected to the relay terminal 58 to mount the fuse 51.

Fuses often are mounted on an electric connection box, and there is a keen desire to have a compact assembly of fuses and a connection box. However, the conventional fuse 51 is not well suited for such a compact design. More particularly, to achieve a firm connection between the contacts 58b/58b and the input/output terminals 53/54 of the fuse 51, the fuse 51 and the contacts 58b should satisfy the equation da+db+dc≦Da, where: Da is the projection length of each of the input and output terminals 53 and 54; da is the thickness of the box housing 59; db is the distance between the distal end of the relay terminal 58 and the contact point; and dc is an allowance distance, as shown in FIGS. 10 and 11. Therefore, the projection length Da of the input/output terminal 53/54 is large, and the fuse 51 has a large height.

The attachment of the relay terminal 58 to the tab 57 also increases the height and complicates attempts to achieve a compact design of the electric connection box.

Furthermore, the number of electrical or electronic parts mounted on automobiles has been increasing, and, accordingly, the number of fuses for protecting these parts has been increasing. Therefore the fuse-mounting portion has been increasing in size, and this further complicates efforts to achieve a compact design for the electric connection box.

This invention has been made in view of the above problems, and an object of the invention is to provide a fuse and an electric connection box with a compact design.

### SUMMARY OF THE INVENTION

The invention is directed to a fuse comprising a casing made of an insulating resin; and a conductor having one input terminal, at least one output terminal and at least one fusible portion interconnecting the input terminal and a corresponding output terminal. The conductor is mounted at least partly in the casing so that distal end surfaces of the input and output terminals and one end surface of the casing are substantially on a common plane. A plurality of pairs of notches are formed in opposite or obverse and reverse surfaces of the casing, and each pair of notches extends a predetermined distance from the distal end surface of the corresponding terminal in such a manner that each of the input and output terminals is partially exposed. The exposed portion of each input and output terminal serves as an electrical contact portion for contact with a mating terminal. Thus, overall height of the fuse is reduced.

The pairs of notches are formed in the opposite surfaces of the and preferably at those regions at which the input and output terminals are provided. Additionally, the notches in each pair extend from the distal end surface of the corresponding terminal in such a manner that the opposite surfaces of each of the input and output terminals are partially exposed to provide the electrical contact portion of a necessary length for contact with the mating terminal.

The input and output terminals do not need to project downwardly from the end surface of the casing, as in the conventional construction. Rather, each terminal can be contacted electrically with the mating terminal even though the distal end surface of each of the input and output terminals and the one end surface of the casing are substantially on a common plane.

The phrase “substantially on a common plane” does not always mean that the end surfaces of the input and output terminals and the end surface of the casing must be precisely in the same plane. Rather, the ends need only be generally on a common plane, and a deviation e.g. of about 1 mm is acceptable. Furthermore, in instances where the end surface of each terminal terminates short of the end surface of the casing, a larger deviation is allowable.

Therefore, the overall height of the fuse of the invention can be reduced by an amount corresponding to the amount of projection of the input and output terminals from the one end surface of the casing of the conventional fuse, so that the fuse can have a compact size.

According to a preferred embodiment of the invention, the length of the fusible portions exceeds the distance between the input terminal and the respective output terminal so that the fusible portions are bent, snake-like or arcuate.

The fusible portions preferably are arranged at a distance from the common plane that is less than or equal to the predetermined distance of the notches.

The fuse preferably is a multi-fuse in which several output terminals are connected with a single input terminal via a corresponding number of fuse-fusible portions. With this construction, a single fuse of the invention can replace two or more fuses of the typical prior art construction. Therefore the space occupied by the fuses can be reduced, and the electric connection box can be more compact.

The distal ends of the input and output terminals preferably are tapered in the thickness direction so that the thickness of each input and output terminal decreases progressively toward the distal end. However, the distal ends of the input and output terminals do not taper in the width direction, and therefore each input and output terminal has a sufficient width up to the distal end. With this configuration, the input and output terminals of the fuse can be inserted easily into the terminal press-contacting slot in the tab. Additionally, even when the input and output terminals of the fuse are displaced slightly in the width direction, the terminal can be inserted quickly into the terminal press-contacting slot since the distal ends of the input and output terminals have a sufficient width up to the distal end.

According to the invention, there is further provided an electric connection box on which the above fuse is mountable. More specifically, the fuse is mountable in a fuse-receiving portion of a housing of the electric connection box. A tab with a press-contacting slot is formed integrally or unitarily on each bus bar and can be received at least partly in the housing. Additionally, the tabs project at least partly into the fuse-receiving portion. The exposed portion of each of the input and output terminals is insertable into the press-contacting slot in the corresponding tab, and is held in electrical contact with the tab.

The fuse-receiving portion, into which the casing of the fuse can be fitted, preferably is at an obverse surface of the housing of the electric connection box. Terminal insertion ports are formed through a bottom wall of the fuse-receiving portion, and the tabs of the bus bars that are received in the housing project through the respective terminal insertion ports. The distal end of each tab is divided in a width direction to provide two divisions, and therefore a terminal press-contacting slot is formed in the distal end of the tab. As a result, the exposed portion of the terminal of the fuse can be inserted between the two divisions of the tab generally over an entire length thereof. Accordingly, the terminal inserted between the two divisions of the tab can be held between and gripped by inner edges of distal ends of the two divisions held respectively against the obverse and reverse surfaces of the terminal.

Each terminal of the fuse is insertable into the press-contacting slot until the proximal end of that portion of the terminal, exposed through the notches, is received in the slot. With this construction, each input and output terminal is gripped positively by the tab of the corresponding bus bar, and is held in electrical contact therewith. The distance from the area of contact between the terminal and the bus bar to the other end surface of the fuse casing can be shortened.

The terminal press-contacting slot for receiving the fuse terminal in a press-contacted manner is formed in the distal end of the tab. Accordingly, it is not necessary to use a relay terminal, and hence the height of the electric connection box can be reduced.

Each bus bar preferably is disposed such that a distal end substantially abuts against end surfaces of the corresponding notches when one end surface of the casing of the fuse is held against a bottom wall of the fuse receiving portion.

Each tab preferably comprises two opposed spring contact arms that define the press-contacting slot therebetween. The distal ends of the spring arms preferably comprise projecting portions that project towards each other.

These and other objects, features and advantages of the present invention will become more apparent upon reading of the following detailed description of preferred embodiments and accompanying drawings. It should be understood that even though embodiments are separately described, single features thereof may be combined to additional embodiments.

### BRIEF DESCRIPTION OF THE DRAWINGS

FIG. 1A is a front-elevational view showing the construction of a preferred embodiment of a fuse of the invention, and FIG. 1B is a side-elevational view thereof.

FIG. 2 is a plan view showing the construction of a preferred embodiment of an electric connection box of the invention.

FIG. 3 is a front-elevational view showing the construction of a fuse receiving portion and its neighboring portion in the electric connection box.

FIG. 4 is a cross-sectional view showing the construction of a press-contacting slot in a distal end portion of a tab.

FIG. 5 is a perspective view of the tab mounted in the electric connection box of the above embodiment.

FIG. 6 is a front-elevational view showing a condition in which the fuse is mounted on the electric connection box.

FIG. 7 is a cross-sectional view showing a condition in which the fuse is mounted on the electric connection box.

FIG. 8 is a front-elevational view showing the construction of a conventional fuse.

FIG. 9 is a perspective view showing a conventional tab and a conventional relay terminal.

FIG. 10 is a cross-sectional view showing a condition in which the conventional relay terminal and fuse are connected together.

FIG. 11 is a front-elevational view showing a (input/output) terminal of the conventional fuse.

### DETAILED DESCRIPTION OF THE PREFERRED EMBODIMENTS

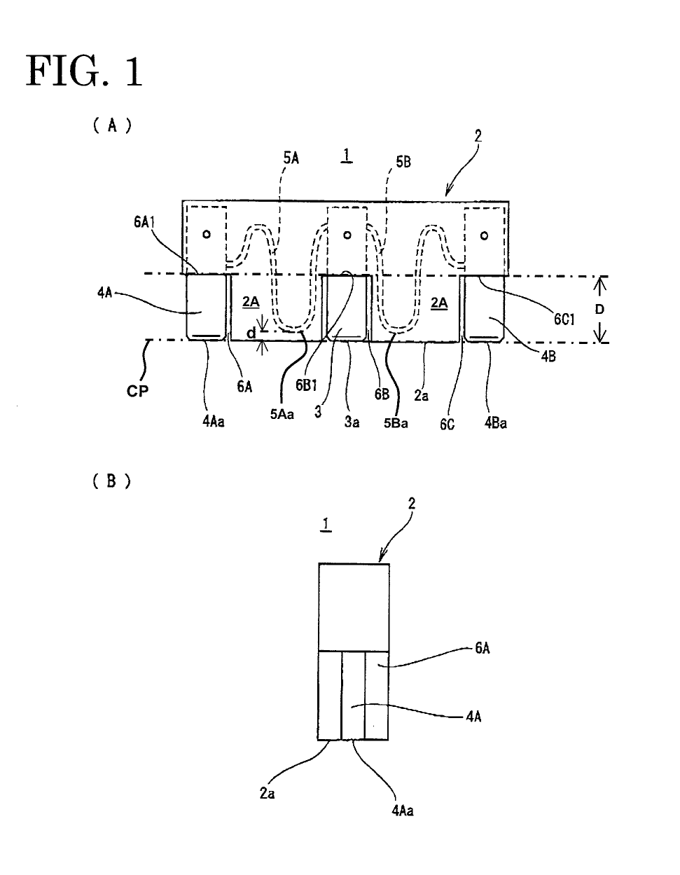

A fuse according to the invention is identified by the numeral 1 in FIGS. 1A and 1B. The fuse 1 includes a casing 2 made e.g. of a transparent, insulating resin, and a conductor of an integral or unitary construction having at least one input terminal 3, first and second output terminals 4A and 4B and first and second fusible portions 5A and 5B. The conductor is blanked from an electrically-conductive metal sheet and may be insert molded in the casing 2 or mounted into a premolded casing 2. Although two output terminals 4A and 4B and two fusible portions 5A and 5B are illustrated, it should be understood that only one output terminal and fusible portion or more than two output terminals and fusible portions may be provided.

The input terminal 3 and the output terminals 4A and 4B are juxtaposed to one another in such a manner that their distal end surfaces 3a, 4Aa and 4Ba and one end surface 2a of the casing 2 are substantially disposed on a common plane CP. Portions of the first output terminal 4A and the input terminal 3 within the casing 2 are interconnected electrically by the first fusible portion 5A, while portions of the second output terminal 4B and the input terminal 3 within the casing are electrically interconnected electrically by the second fusible portion 5B.

Each fusible portion 5A, 5B is longer than the distance between the input terminal 3 and the corresponding output terminal 4A, 4B so that the fusible portions 5A, 5B are arranged in a bent, snake-like or arcuate configuration having one or more bent portions 5Aa, 5Ba. The fusible portions 5A, 5B are connected laterally to the respective terminals 3, 4A, 4B.

A plurality of pairs of notches 6A to 6C extend into the end surface 2a of the casing 2, and are formed in substantially opposite surfaces of the casing 2. The notches 6A to 6C are disposed at regions corresponding respectively to the terminals 3, 4A and 4B. Each pair of notches 6A-6C extends a predetermined distance D from the distal end surface 3a, 4Aa, 4Ba of the corresponding terminal 3, 4A, 4B in such a manner that the opposite surfaces of each of the input and output terminals 3, 4A and 4B are exposed at least partially to the lateral side.

Part of each fusible portion 5A, 5B is in a region 2A of the casing 2 that corresponds to a contact or exposed portion of the terminals 3, 4A, 4B. More particularly, at least part of each fusible portion 5A, 5B is at a distance d from the plane CP or the distal end 2a of the casing 2, which is smaller than or equal to the distance D of end surfaces 6A1-6C1 of the notches 6A-6C from the common plane CP or from the distal end 2a of the casing 2.

The obverse and reverse or opposing surfaces of each of the terminals 3, 4A and 4B are exposed over a sufficient length to serve as an electrical contact portion for contact with a mating terminal. Therefore, each terminal 3, 4A, 4B does not project down from the end surface 2a of the casing 2 as in the conventional construction, and the terminal can be contacted electrically with the mating terminal even when the distal end surfaces 3a, 4Aa and 4Ba of the terminals 3, 4A and 4B and the one end surface 2a of the casing 2 are on a common plane. Therefore, the overall height of the fuse of the invention can be reduced by an amount corresponding to the projection of the input and output terminals from the end surface of the casing of the conventional fuse, and hence, the fuse of the subject invention has a compact size.

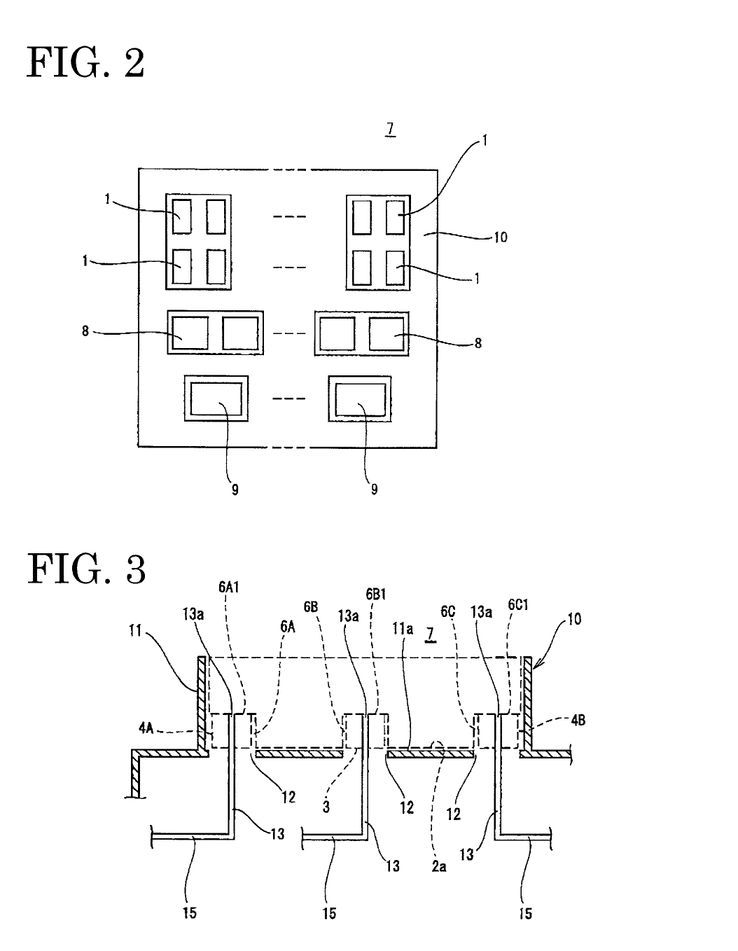

As shown in FIG. 2, mounting portions for mounting many fuses 1, relays 8 and connectors 9 and/or other electric/electronic devices (not show) are provided at a first surface of an electric connection box 7. As shown in FIG. 3, fuse receiving portions 11 are formed on and project from the first surface of a housing 10 of the electric connection box 7 and are dimensioned for receiving the casings 2 of the fuses 1. Insertion ports 12 are formed through bottom walls 11 a of the fuse-receiving portions 11 for receiving tabs 13 that project from a corresponding bus bar 15. More particularly, the distal end portion of the bus bar 15 is bent to define an integral or unitary tab 13 that is received in the electrical connection box 7. Each bus bars 15 is disposed such that when the end surface 2a of the casing 2 is held against the bottom wall 11a of the fuse receiving portion 11, a distal end 13a of each bus bar 15 abuts against end surfaces 6A1, 6B1, 6C1 of the corresponding notches 6A, 6B, 6C.

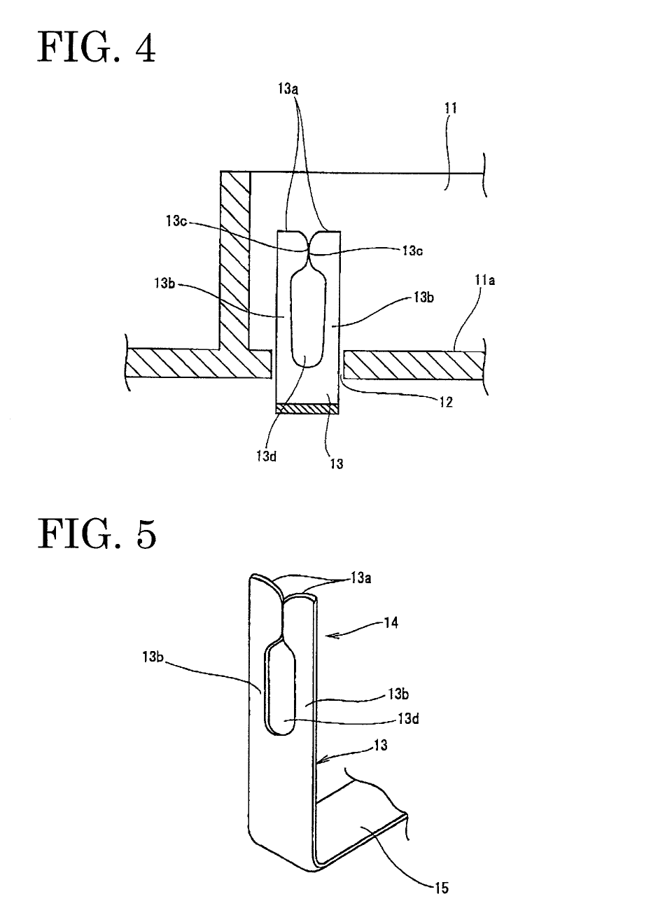

As shown in FIGS. 4 and 5, the distal end portion of the tab 13 is divided in the width direction to define two contact arms 13b and 13b and a terminal press-contacting slot 14 between contact arms 13b and 13b. Distal ends of the contact arms 13b and 13b are characterized by inner edges 13c and 13c that bulge toward one another. However, proximal ends of the contact arms 13b and 13b are spaced from one another to define a gap 13d therebetween. The exposed portion of a terminal 3, 4A or 4B of the fuse 1 can be inserted between the two contact arms 13b and 13b over an entire length thereof, and thus the terminal 3, 4A, 4B can be held between and gripped by the bulging inner edges 13c and 13c at the distal ends of the contact arms 13b and 13b. The inner edges 13c and 13c are configured and dimensioned to require the contact arms 13b and 13b to be deflected resiliently or elastically away from each other to accommodate part of the corresponding terminal 3, 4A, 4B therebetween.

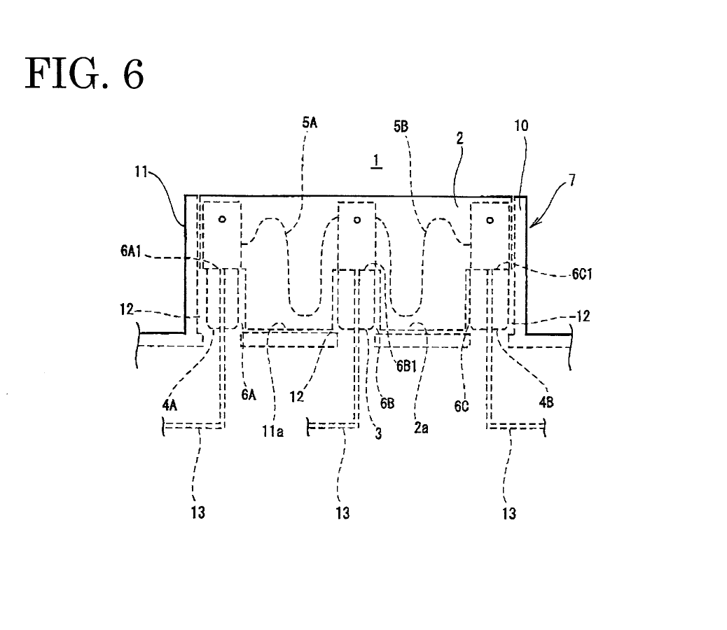

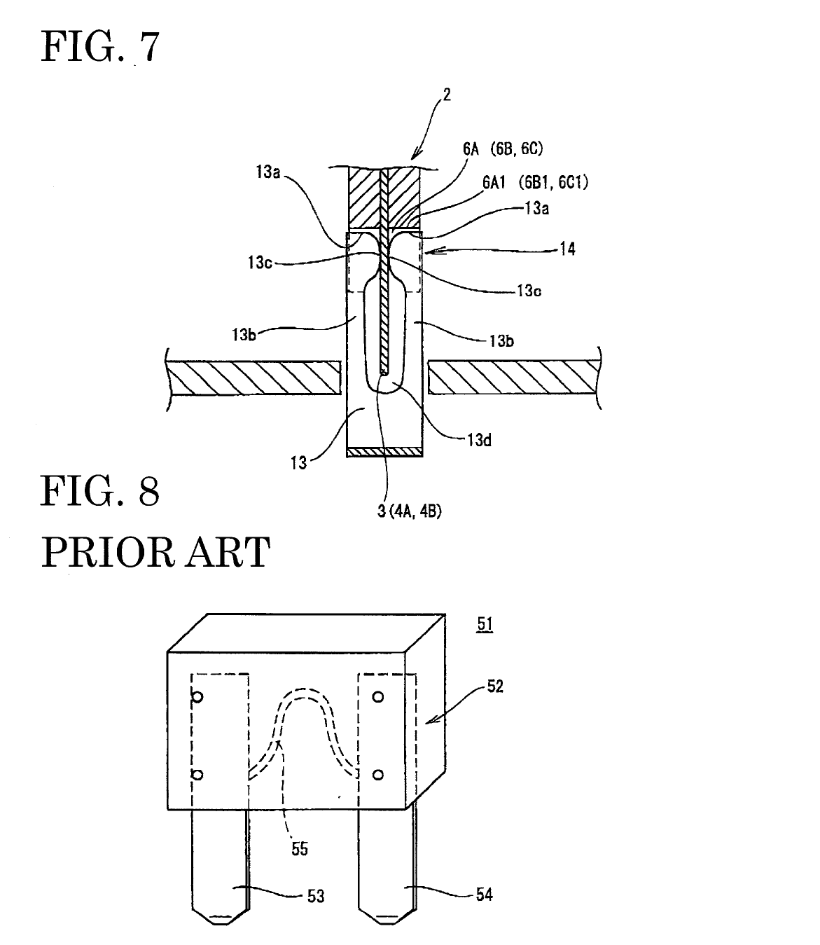

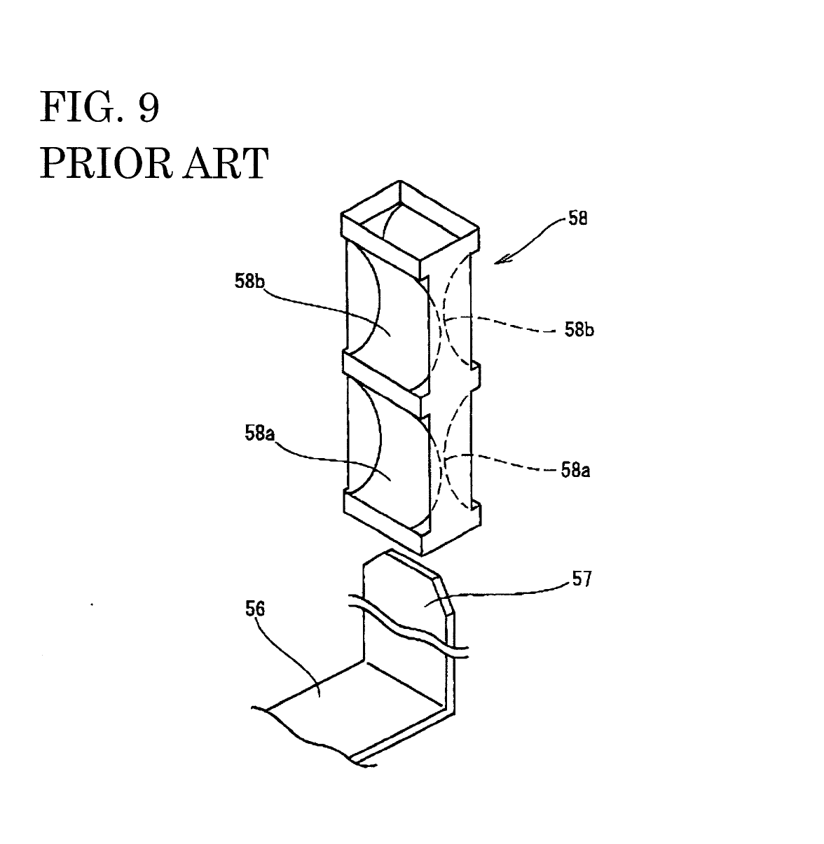

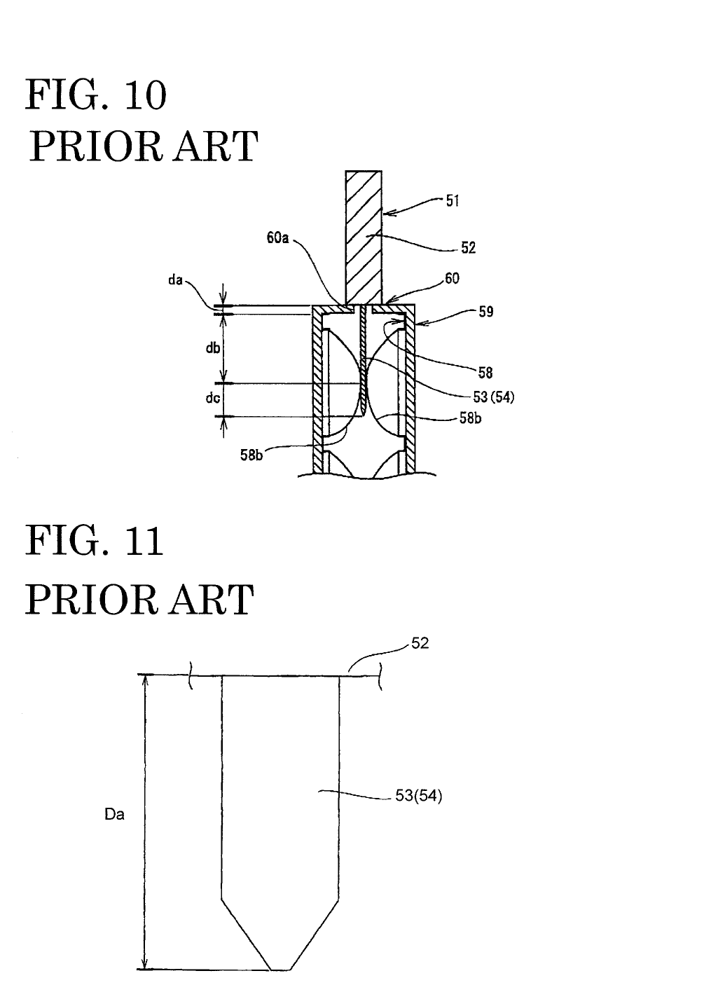

The fuse is inserted into the fuse receiving portion 11 on the electrical connection box 7, as shown in FIG. 6, so that the terminals 3, 4A and 4B are press-fit into the press-contacting slot 14 in the corresponding tab 13. The end surface 2a of the casing 2 is held substantially against the bottom wall 11 a of the fuse receiving portion 11, and, in this condition, the proximal end portion of the terminal 3, 4A, 4B that is exposed through the notches 6A, 6B, 6C, is held between and gripped by the inner edges 13c and 13c of the distal end portions of the two contact arms 13b and 13b. More particularly, that portion of each of the terminals 3, 4A and 4B, disposed near to its proximal end portion, is press-contacted with the inner edges 13c and 13c of the distal end portions of the two contact arms 13b and 13b from a lateral side or direction. As a result, the fuse 1 is mounted on the electric connection box 7, with each terminal 3, 4A, 4B firmly connected to the corresponding tab 13.

The terminal press-contacting slot 14 is formed in the distal end portion of the tab 13, and the exposed portion of the terminal 3, 4A, 4B can be inserted between and gripped by the slot 14 generally over the entire length thereof. Therefore, there is no need to use a relay terminal, and the size of the electric connection box can be reduced.

Although the common input terminal 3 is disposed at the central portion of the fuse 1, the common input terminal 3 may be disposed at the left end portion or the right end portion.

The notches are formed in the obverse and reverse or opposing surfaces of the casing, and are at regions that would otherwise cover the input and output terminals. Each pair of notches extend from the distal end surface of the corresponding terminal in such a manner that the obverse and reverse or opposing surfaces of each of the input and output terminals are at least partially exposed to provide the electrical contact portion of a necessary length for contact with the mating terminal. Therefore, even when the distal end surface of each of the input and output terminals and the end surface of the casing are disposed in the common plane, the terminal can be brought into electrical contact with the mating terminal. As a result, the overall height of the fuse can be reduced by an amount corresponding to the amount of projection of the input and output terminals from the one end surface of the casing of the conventional fuse, so that the fuse can have a compact size.

The fuse of a preferred embodiment of the invention is a multi-fuse in which plural output terminals are connected to the single input terminal by the respective fuse-fusible portions. With this construction, a plurality of prior art fuses can be replaced by the single fuse of the subject invention. Therefore the compact design of the electric connection box can be achieved more easily.

The electric connection box of the invention has a press-contacting slot into which the fuse terminal can be press-fitted for connection with a tab formed on or projecting from a bus bar. Thus, the terminal is connected electrically directly to the bus bar without a relay terminal. With this construction, the number of the component parts is reduced, and the height of the electric connection box can be reduced, thus achieving the compact design.

What is claimed is:

1. A fuse (1) comprising:
a casing (2) made of an insulating resin, said casing (2) having an end surface (2a); and
a conductor having one input terminal (3), at least one output terminal (4A; 4B) and at least one fusible portion (5A; 5B) interconnecting said input terminal (3) and the output terminal (4A; 4B), said conductor being at least partly mounted within said casing (2);
wherein distal end surfaces (3a; 4Aa; 4Ba) of said input and output terminals (3; 4A; 4B) and said end surface (2a) of said casing (2) are disposed substantially on a common plane (CP), and a plurality of pairs of notches (6A-6C) being formed in opposite surfaces of said casing (2), and each said pair of notches (6A-6C) extending a predetermined distance (D) from the distal end surface (3a; 4Aa; 4Ba) of the corresponding terminal (3; 4A; 4B), such that a portion of each of said input and output terminals (3; 4A; 4B) is partially exposed by a corresponding pair of the notches (6A-6C), whereby the portion of each of said input and output terminals (3; 4A; 4B) exposed by one of said pairs of notches (6A-6C) defines an electrical contact portion for a mating terminal (13).

2. The fuse of claim 1, wherein the length of said fusible portion (5A; 5B) is longer than the distance between the input terminal (3) and the output terminal (4A; 4B) so that the fusible portion (5A; 5B) comprises substantially bent portions (5Aa; 5Ba).

3. The fuse of claim 1, wherein the fusible portion (5A; 5B) is arranged at a distance (d) from the common plane (CP) that is no greater than the distance (D) of the notches (6A-6C) from the surface (2a) of the casing (2).

4. The fuse of claim 1, wherein the at least one output terminal (4A; 4B) comprises a first output terminal (4A) and a second output terminal (4B), and wherein the at least one fusible portion (5A; 5B) comprises a first fusible portion (5A) and a second fusible portion (5B), the first fusible portion (5A) connecting the input terminal (3) and the first output terminal (4A), and the second fusible portion (5B) connecting the input terminal (3) and the second output terminal (4B).

5. The fuse of claim 1, wherein portions of each of the input and output terminals (3; 4A; 4B) adjacent said common plane (CP) are tapered in a thickness direction.

6. A fuse-mounting electric connection box (7), comprising:
a fuse (1) having a casing (2) made of an insulating resin, said casing (2) having an end surface (2a) and a conductor having one input terminal (3), at least one output terminal (4A; 4B) and at least one fusible portion (5A; 5B) connecting said input terminal (3) and the output terminal (4A; 4B), said conductor being at least partly mounted within said casing (2); distal end surfaces (3a; 4Aa; 4Ba) of said input and output terminals (3; 4A; 4B) and said end surface (2a) of said casing (2) being disposed substantially on a common plane (CP), and a plurality of pairs of notches (6A-6C) being formed in opposite surfaces of said casing (2), and each said pair of notches (6A-6C) extending a predetermined distance (D) from the distal end surface (3a; 4Aa; 4Ba) of the corresponding terminal (3; 4A; 4B), such that a portion of each of said input and output terminals (3; 4A; 4B) is partially exposed by a corresponding pair of the notches (6A-6C);
a housing (10) with at least one fuse receiving portion (11), and a plurality of bus bars (15), each said bus bar (15) having a tab (13) unitary with the bus bar (15), a press-contacting slot (14) formed in each said tab (13), and each said tab (13) at least partly projecting into one said fuse receiving portion (11); and
wherein said exposed portion of each of said input and output terminals (3; 4A; 4B) is insertable into said press-contacting slot (14) in the corresponding tab (13), and is holdable in electrical contact with said tab (13).

7. The fuse-mounting electric connection box of claim 6, wherein each of the bus bars (15) is disposed such that when one end surface (2a) of the casing (2) of the fuse (1) is held against a bottom wall (11a) of the fuse receiving portion (11), a distal end (13a) of each bus bar (15) substantially abuts against end surfaces (6A1; 6B1; 6C1) of the corresponding notches (6A-6C).

8. The fuse-mounting electric connection box of claim 6, wherein the tab (13) comprises two spring arms (13b) substantially opposed to each other an defining the press-contacting slot (14) therebetween.

9. The fuse-mounting electric connection box of claim 8, wherein the spring portions (13b) each comprise at their distal end a projecting portion (13c) projecting towards each other.

10. A fuse (1) comprising:
a conductor having one input terminal (3) and first and second output terminals (4A; 4B), a first fusible portion (5A) connecting said input terminal (3) and the first output terminal (4A) and a second fusible portion (5B) connecting said input terminal (3) and second output terminal (4B), said input terminal (3) and said output terminals (4A; 4B) having distal ends (3a; 4Aa; 4Ba) lying in a common plane (CP); and
a casing (2) made of an insulating resin and surrounding said fusible portions (5A; 5B) and areas of said input terminal (3) and said output terminals (4A; 4B) spaced from said distal ends (3a; 4Aa; 4Ba), said casing (2) having an end surface (2a) lying substantially in said common plane, and a plurality of notches (6A-6C) formed at locations of said casing adjacent said end surface (2a) and exposing portions of said input terminal (3) and said output terminals (4A; 4B) adjacent said distal ends (3a; 4Aa; 4Ba).

11. The fuse of claim 10, wherein said fist and second fusible portions (5A; 5B) are non-linear.

12. The fuse of claim 10, wherein said input terminal (3) and said first and second output terminals (4A; 4B) are substantially coplanar.

13. The fuse of claim 10, wherein portions of said input terminal (3) and said output terminals (4A; 4B) adjacent said distal ends (3a; 4Aa; 4Ba) are tapered.

14. The fuse of claim 10, wherein the fusible portion (5A; 5B) is arranged at a distance (d) from the common plane (CP) that is no greater than a dimension (D) of the notches (6A-6C) from the end surface (2a) of the casing (2).
